(19) United States
(12) Patent Application Publication
(10) Pub. No.: US 2006/0087719 A1
(43) Pub. Date: Apr. 27, 2006

(54) Particles for particle movement type display apparatus, process for producing the particles, and display apparatus

(76) Inventor: Tetsuya Kosuge, Kawasaki-shi (JP)

Correspondence Address: MORGAN & FINNEGAN, L.L.P., 3 WORLD FINANCIAL CENTER, NEW YORK, NY, 10281-2101, US

(21) Appl. No.: 11/255,355

(22) Filed: Oct. 20, 2005

(30) Foreign Application Priority Data
Oct. 22, 2004 (JP) 308626/2004

(51) Int. Cl. G02B 26/00

(52) U.S. Cl. 359/296

(57) ABSTRACT

Particles for a particle movement type display apparatus is prepared by forming and fixing a polymeric compound at a surface of pigment particle or composite particle comprising a colorant and a polymer by a precise ionic polymerization.

### FIELD OF THE INVENTION AND RELATED ART

The present invention relates to particles for a particle movement type display apparatus, a process for producing the particles, and a display apparatus.

In recent years, with development of information equipment, the needs for low-power and thin display devices have grown, so that extensive study and development have been made on display devices fitted to these needs.

As one of such display devices, an electrophoretic display device has been known (Paul F. Evans et al; U.S. Pat. No. 3,612,758).

In the electrophoretic display device, a multiplicity of electrophoretic particles which are positively charged and colored are dispersed in a space between a pair of substrates, each provided with an electrode, together with an electrophoretic dispersion liquid which is filled in the space and colored a color different from the color of the electrophoretic particles. In the space, a partition wall is formed so that it divides the space into a multiplicity of pixels along a planar direction of the substrates. By forming such a partition wall, it is possible to define the space between the pair of substrates while preventing localization of the electrophoretic particles.

In such an electrophoretic display device, when a positive-polarity voltage is applied to an observer's side electrode and a negative-polarity voltage is applied to an electrode on an opposite side, the positively charged electrophoretic particles are collected so as to cover the opposite side electrode, so that a color identical to the color of the electrophoretic dispersion medium is displayed when the electrophoretic display device is observed from the observers side.

On the other hand, when a negative-polarity voltage is applied to the observer's side electrode and a positive-polarity voltage is applied to the opposite side electrode, the positively charged electrophoretic particles are collected so as to cover the observer's side electrode, so that a color identical to the color of the electrophoretic particles is displayed when the electrophoretic display device is observed from the observer's side.

By performing such a drive of the electrophoretic display device on a pixel-by-pixel basis, any image or character is displayed by a multiplicity of pixels.

Particles for a particle movement type display apparatus using such a particle movement type display device are required to be colored and dispersed with a uniform particle size and have been proposed as those of various types.

In order to obtain particles, for a particle movement type display apparatus, having a good dispersibility, it has been known that a polymer shell layer comprising a polymer is formed at a surface of colored core (base) particle.

Electrophoretic particles comprising pigment particles as, core particles, at each surface of which grafting of a polymer chain is performed have been described in U.S. Pat. Nos. 5,932,633 and 5,914,806.

In U.S. Pat. No. 5,932,633, electrophoretic particles constituted by pigment particles, at each surface of which, elongation grafting of a polymer chain is performed by free radical polymerization initiated from a radical polymerization initiation group incorporated at a surface of pigment particle and a production process for the electrophoretic particles have been disclosed.

In U.S. Pat. No. 5,914,806; electrophoretic particles constituted by pigment particles, at each surface of which, implantation grafting of a polymer chain is performed by fixation of a preliminarily prepared polymeric stabilizer to a surface of pigment particle and a production process for the electrophoretic particles have been disclosed.

Further, Japanese Laid-Open Patent Application (JP-A) No. 2004-18556 has disclosed a process for producing spherical polymer fine particles having a uniform particle size and a process for producing a functional spherical composite particles comprising core particles, at each surface of which, a polymer chain having a uniform chain length is formed.

These particles used in a particle movement type display apparatus are required to have an excellent charge stability and a good dispersibility.

Depending on a difference in these characteristics, a driving characteristic of the particles also vary, thus largely affecting a display quality. For this reason, the particles are particularly required to provide a less irregularity in these characteristics between the particles. Further, in an electrophoretic display apparatus using such particles in a state in which the particles are dispersed in an insulating liquid, these characteristics are stable for a long period of time particularly in a liquid.

### SUMMARY OF THE INVENTION

An object of the present invention is to provide particles, for a particle movement type display apparatus, having a polymer coating layer with a controlled structure and provide a process for producing the particles.

Another object of the present invention is to provide a particle movement type display apparatus excellent in display characteristic by the use of which particles for the particle movement type display apparatus.

In order to solve the above described problems, as a result of extensive studies of the present invention, particles for a particle movement type display apparatus having a polymer coating layer with well controlled structure compared with those for a conventional particle movement type display apparatus have been found. As a result, the present invention has been accomplished.

According to an aspect of the present invention, there is provided a process for producing particles for a particle movement type display apparatus, comprising:

a step of preparing at least one of pigment particles or composite particles comprising a colorant and a polymer, and

a step of forming and fixing a polymeric compound at a surface of pigment particle or composite particle by a precise ionic polymerization.

According to another aspect of the present invention, there is provided particles for particle movement type display apparatus, comprising: particles which comprise pigment particles or composite particles comprising a colorant and a polymer, and a polymeric compound which is prepared by a precise ionic polymerization and is fixed at a surface of pigment particle or composite particle by a covalent bond.

In the particle movement type display apparatus, the polymeric compound which is fixed at the surface of pigment particle or composite particle may preferably have a molecular weight distribution index (weight-average molecular weight/number-average molecular weight) of not more than 1.8, more preferably not more than 1.5 in the case where the polymeric compound is fixed to the pigment particle itself.

According to a further aspect of the present invention, there is provided an electrophoretic display apparatus, comprising:

particles for a particle movement type display apparatus described above,

a container for containing a dispersion liquid which contains a dispersion medium for dispersing the particles,

a display portion provided in at least a part of the container, and

voltage application means for applying a voltage for causing movement of the particles to the display portion depending on display information.

The above described particles for the particle movement type display apparatus according to the present invention are excellent in dispersibility and stably charged electrically, and are used effectively in the above described production process and display apparatus according to the present invention.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIGS. 1(a) and 1(b) are schematic sectional views showing an embodiment of an electrophoretic display device using, as electrophoretic particles, particles for a particle movement type display apparatus according to the present invention.

FIGS. 2(a) and 2(b) are schematic views showing a display example of the electrophoretic display device.

FIGS. 3(a) and 3(b) are schematic views showing another display example of the electrophoretic display device.

FIGS. 4(a) and 4(b) are schematic sectional views showing another embodiment of an electrophoretic display device using the particles for the particle movement type display apparatus of the present invention.

FIGS. 5(a) and 5(b) are schematic views showing a display example of the electrophoretic display device of the another embodiment.

### DETAILED DESCRIPTION OF THE PREFERRED EMBODIMENTS

The present invention includes a first invention characterized in that a polymeric compound is fixed at a surface of composite particle by a precise ionic polymerization and a second invention characterized in that the polymeric compound is fixed a surface of pigment particle by the precise ionic polymerization.

First, the first invention will be described.

With respect to particles for a particle movement type display apparatus according to the first invention, at the surface of composite particles each comprising a colorant and a polymer (hereinafter, referred also to as “core particles”), a polymeric compound prepared by a precise ionic polymerization is fixed through covalent bond.

Core particles are composite particles each comprising the colorant and the polymer, and the colorant may be completely incorporated into the polymer particle or partially exposed at the surface of the polymer particle.

The colorant principally comprises at least one species of a pigment or dye. In the case of the pigment, one or a plurality of pigment particles are contained in core particle and color the core particle. In the case of the dye, the dye is mixed and dispersed in the polymer to dye the polymer.

Further, in the present invention, at the surface of core particle, it is necessary to introduce a functional group X as a precursor of covalent bond.

The above described core particles can be prepared by a conventionally known production process, so that it is possible to prepare core particles having a desired functional group X at each surface thereof.

In the present invention, a polymer coating layer is constituted by a polymeric compound prepared by a precise ionic polymerization. The precise ionic polymerization used in the present invention is a precise cationic polymerization or a precise anionic polymerization. The precise ionic polymerization has the following features A-D.

A. One molecular of a polymer chain is formed from one molecule of a polymerization initiator.

B: It is possible to prepare precisely and efficiently a linear polymer having a narrow molecular weight distribution (uniform chain length).

C. It is possible to prepare precisely and efficiently a copolymer with a well controlled structure.

D. It is possible to prepare precisely and efficiently a terminal-functional polymer.

With respect to the feature C, this feature can be realized by polymerizing at least two species of monomers. For example, in the case of polymerizing two or more species of monomers in stages, it is possible to obtain a block polymer in which a sequence and a length of each segment are clearly specified. On the other hand, in the case of polymerizing two or more species of monomers together in one stage, it is possible to obtain a random copolymer in which a presence ratio between respective monomers is clearly specified in accordance with chain lengths.

With respect to the feature D, the polymer can be prepared by using an initiator having a functional group Y for bonding to core particle (hereinafter referred to as a “functional polymerization initiator”) as a polymerization initiator. Alternatively, the polymer can be prepared by using a terminator having a functional group Z for bonding to core particle (hereinafter referred to as a “functional (polymerization) terminator”) as a polymerization terminator.

Further, by using the functional initiator and the functional terminator in combination, it is also possible to prepare a polymer having both terminal functional groups. The functional groups Y and Z may be their precursors during the polymerization reaction. In this case, the precursors may be converted into desired functional groups by performing an appropriate treatment after completion of the polymerization. Further, it is also possible to form the functional groups Y and Z during the polymerization process.

Based on the above described features of the precise ionic polymerization, a polymer coating layer formed of the polymeric compound prepared by the precise ionic polymerization is structurally controlled precisely. More specifically, the polymer coating layer can be designed in a desired thickness and formed in a uniform thickness. Further, as described above in the feature C, it is possible to effect molecular structure design of the polymer constituting the polymer coating layer with precision and high degree of freedom, so that the resultant polymer coating layer can impart desired functions, such as dispersibility, electrical chargeability, and the like, to the particle.

In the present invention, the fixation of the core particle and the polymer coating layer by covalent bond may be performed by either one of both of the following two grafting methods (i) and (ii):

(i) Elongation grafting of a polymer chain from a core particle surface by the precise ionic polymerization, and

(ii) Implantation grafting of a polymer chain prepared by the precise ionic polymerization into a core particle surface.

In the case of the elongation grafting (i), first, an initiation group for the precise ionic polymerization is introduced onto the core particle surface. More specifically, the functional group X on the core particle surface may be covalently bonded to the functional group Y of the functional initiator. Further, the polymerization initiation group of the functional initiator may also be a precursor thereof. The precursor may be converted into the polymerization initiation group after it is introduced onto the core particle surface. Next, a polymer chain is prepared from the surface polymerization initiation group by the precise ionic polymerization. As another method of the elongation grafting (i), the functional group X on the core particle surface may also be originally a precise ionic polymerization initiation group. In this case, from the polymerization initiation group, the polymer chain may be prepared by the precise ionic polymerization.

On the other hand, in the case of the implantation grafting (ii), the terminal functional polymer is prepared in advance by the precise ionic polymerization. More specifically, as described with respect to the feature D, the polymerization may be performed with the use of the functional initiator or the functional terminator. Thereafter, the terminal functional group Y or Z of the polymer is reacted with the functional group X on the core particle surface of fix the polymer on the core particle surface. Further, as another method of the implantation grafting (ii), the functional group X on the core particle surface may also be a polymerization termination group. In this case, when the core particle having the polymerization termination group is used as a terminating agent, a polymer chain is fixed on the core particle surface by covalent bond.

By the above described elongation grafting (i) or implantation grafting (ii), the polymer coating layer is fixed on the core particle surface by covalent bond, so that the particles for the particle movement type display apparatus prepared by the present invention have a high structural stability to stabilize a drive characteristic of a display device.

The process for producing particles for a particle movement type display apparatus according to the present invention includes the process for producing the polymeric compound constituting the polymer coating layer. More specifically, at least one polymerization process is selected from Group I shown below as the polymerization process and at least one grafting method is selected from Group II shown below as the fixation method of the polymer coating layer on the core particle surface.

Group I: precise cationic polymerization and precise anionic polymerization

Group II: elongation grafting and implantation grafting

Accordingly, in the present invention, when a production process including an optimum combination is selected from each of Groups I and II, it becomes possible to precisely and efficiently prepare particles for the particle movement type display apparatus having desired structure and function.

Hereinbelow, respective constituents of the particles for the particle movement type display apparatus in the present invention and their preparation methods will be described more specifically.

(Core Particles)

Core particles having a surface functional group X can be prepared through a conventionally known production process. Generally, the core particles can be obtained by a known polymer fine particle synthesizing method with the use of a colorant, a functional polymerizable monomer having a functional group X or a precursor group thereof, and a polymerizable monomer for core particles. The resultant core particles have a substantially spherical shape. Examples of the known polymer fine particle synthesizing method may include emulsion polymerization, suspension polymerization, precipitation polymerization, soap-free polymerization, mini-emulsion polymerization, etc.

As the colorant, it is possible to use a pigment or a dye singly or in combination. When the pigment and the dye are used in combination, a mixing ratio may be determined appropriately depending on a system used.

As the pigment, it is possible to use an organic pigment, an inorganic pigment, etc.

Examples of organic pigment may include azo pigments, phthalocyanine pigments, quinacridone pigments, isoindolinone pigments isoindolin pigments, dioxazine pigments, perylene pigments, perinone pigments, thioindigo pigments, quinophthalone pigments, anthraquinone pigments, nitro pigments, and nitroso pigments. Specific examples thereof may include: red pigments, such as Quinacridone Red, Lake Red, Brilliant Carmine, Perylene Red, Permanent Red, Toluidine Red and Madder Lake; green pigments, such as Diamond Green Lake, Phthalocyanine Green, and Pigment Green; blue pigments, such as Victoria Blue Lake, Phthalocyanine Blue, and Fast Sky Blue; yellow pigments, such as Hansa Yellow, Fast Yellow, Disazo Yellow, Isoindolinone Yellow, an Quinophthalone Yellow; and black pigments, such as Aniline Block and Diamond Black.

Examples of the inorganic pigment may include: white pigments, such as titanium oxide, aluminum oxide, zinc oxide, lead oxide, and zinc sulphide; black pigments, such as carbon black, manganese ferrite block, cobalt ferrite black, and titanium black; red pigments, such as cadmium red, red iron oxide, and molybdenum red; green pigments, such as chromium oxide, viridian, titanium cobalt green, cobalt green, and victoria green; blue pigments, such as ultramarine blue, prussian blue, and cobalt blue; and yellow pigments, such as cadmium yellow, titanium yellow, yellow iron oxide, chrome yellow, and antimony yellow.

The pigment may preferably have an average particle size of 10-500 nm, more preferably 20-200 nm. Below 10 nm, a handling characteristic is lowered considerably in some cases. Above 500 nm, a degree of pigmentation of the pigment is desirably lowered and the resultant particles are unsuitable for particles, for the particle movement type display apparatus of a smaller size in some cases.

The pigment may preferably be added in an amount of 0.1-30 wt. %, more preferably 1-15 wt. %, with respect to the polymerizable monomer for the core.

The pigment generally has a poor dispersibility, so that when the pigment is dispersed in the polymerizable monomer for the core, the pigment may preferably be dispersed therein after being subjected to surface modification, e.g., in a conventionally known manner.

In the case of using the pigment as the colorant, the dispersion can be performed by a shearing-type dispersion apparatus, such as a homogenizer, a homomixer, a biomixer, and the like; a media-type dispersion apparatus, such as a ball mill, an atriter, a sand mill, and the like; an ultrasonic dispersion apparatus; etc.

As the dye in the case of using it as the colorant, a material therefor is not particularly limited so long as it is soluble in the polymerizable monomer for the core but is not soluble in water or an electrophoretic dispersion medium. Examples of the dye may include those of equalysine-type, azine-type, azo-type, azomethine-type, anthraquinone-type, indigo-type, xanthene-type, dioxazine-type, diphenylmethane-type, thiazine-type, thiazole-type, thioindigo-type, triphenylmethane-type, polymethine-type, and the like. These dyes may be used singly or in combination of two or more species.

The dye may preferably added in an amount of 0.1-30 wt. %, more preferably 1-20 wt. % with respect to the polymerizable monomer for the core.

As the functional group X on the core particle surface, a material therefor is not particularly limited so long as it can form covalent bond by being reacted with the functional initiator or the terminal functional polymer. As exceptions thereto, in the case where the functional group X is the precise ionic polymerization initiation group or the precise ionic polymerization termination group, it is not necessarily required to be reacted with the functional initiator or the terminal functional polymer.

Specific examples of the functional group X may include hydroxyl group, isocyanate group, epoxy group, carboxylic acid chloride group, sodium carboxylate group, alkyl halide group, amino group, vinyl group, vinyloxy group, etc.

The functional polymerizable monomer having a desired functional group X or a precursor group thereof is polymerized together with the colorant and a polymerizable monomer for the core, whereby it is possible to prepare core particle having the functional group at each particle surface.

A mixing ratio between the polymerizable monomer having the functional group X and the polymerizable monomer for the core having no such a functional group can be appropriately selected depending on an amount of polymer chain to be subjected to grafting. For example, the mixing ratio can be selected from a range of 1:1000 to 1:4 (weight ratio). Further, an amount of the polymerization initiator in the case of using it is only required to be a necessary amount for permitting a desired polymerization reaction. For example, the amount can be selected from a range of 0.01-5 wt. % per the total amount of the above described two types of the polymerizable monomers.

(Precise Ionic Polymerization)

The precise ionic polymerization used in the present invention is a precise cationic polymerization or a precise anionic polymerization and is an ionic polymerization by which a molecular weight distribution index (weight-average molecular weight/number-average molecular weight) of a polymer to be prepared is not more than 1.8. The precise ionic polymerization may be preferably be a living anionic polymerization or a living cationic polymerization capable of producing a polymer having the molecular weight distribution index of not more than 1.2. When the molecular weight distribution index exceeds 1.8, it is difficult to say that a polymer chain length is uniform, and the particles for the particle movement type display apparatus are liable to cause irregularities in dispersibility and electrical chargeability in some cases.

(Precise Cationic Polymerization)

The precise cationic polymerization is a polymerization process using a cationic species as a polymerization active species. The resultant polymer has a molecular weight distribution index close to 1 and is precisely controlled with respect to the number-average molecular weight by the precise cationic polymerization. The precise cationic polymerization is one of known precise ionic polymerization processes and is represented by a living cationic polymerization.

In the precise cationic polymerization in the present invention, polymerization is performed by appropriately combining a polymerization initiator, a cationic polymerizable monomer, Lewis acid polymerization catalyst, an additive, and a polymerization terminator, shown below.

The cationic polymerizable monomer used in the present invention may be a known cationic polymerizable monomer, capable of being polymerized through the precise cationic polymerization, preferably be a vinyl monomer. Examples thereof may include: vinyl ethers, such as methyl vinyl ether, ethyl vinyl ether, isobutyl vinyl ether, cyclohexyl vinyl ether, dodecyl vinyl ether, octadecyl vinyl ether, 2-chloro vinyl ether, and 2-acetoxyethyl vinyl ether; styrenes, such as styrene, p-methoxystyrene, p-tert-butoxystyrene, p-methylstyrene, p-chloromethylstyrene, and a-methylstyrene; isobutene; cyclopendadiene; indan; β-pinene; and N-vinylcarbazol.

Particularly, it is desirable in view of an improvement in dispersibility of the particles that the monomer is selected so that it provides a polymer having a high affinity for an electrophoretic particle dispersion medium. When the polymer chain has a high affinity for the dispersion medium, the polymer chain has an expanse in the electrophoretic particle dispersion medium, thus capable of effectively functioning as a steric hindrance group for preventing agglomeration between particles. Incidentally, herein, the high affinity means that the polymer chain and the electrophoretic particle dispersion medium are excellent in mutual solubility without causing phase separation.

Further, it is desirable in terms of an improvement in electrical chargeability of particles that a monomer having a unit which has a electronegativity different largely from those of the electrophoretic particle dispersion medium and the additive, such as an acidic unit or a basic unit, as the polymerizable monomer is selected.

By combining the resultant acidic or basic polymer with a basic or acidic additive, acid-base interaction between the polymer and the additive is caused to occur, so that it is possible to effectively impart electric chargeability to the particles.

As the polymerization initiator, it is possible to use a conventionally known precise cationic polymerization initiator but in a preferred embodiment, the polymerization initiator is a proton acid adduct of the above described cationic polymerizable monomer. As a specific proton acid, it is possible to use hydrogen chloride, acetic acid, trifluoroacetic acid, etc. Further, it is also possible to use a functional initiator having a functional group Y or a precursor group Y′ thereof, different from the polymerization initiation group.

As the Lewis acid polymerization catalyst, it is possible to use a conventionally known precise cationic polymerization catalyst. Specific examples thereof may include iodine, tin tetrabromide, titanium tetrachloride, ethylaluminum dichloride, zinc dichloride, zinc diiodide, etc.

Examples of the additive may include: Lewis bases, such as diethyl ether, 1,4-dioxane, and ethyl acetate; an additive salt, such as N-tetra-n-butylammonium chloride; and a proton trap, such as 2,6-di-tert-butyl-4-methylpyridine. Further, in some cases, such as additive is not used depending on the polymerization initiator system employed.

Examples of the polymerization terminator may include alcohols, water, sodium diethylmalonate, sodium alkoxides, sylylenol ethers, Grignard reagent, etc. The polymerization initiator also includes a functional terminator having a functional group Z or a precursor group Z′ thereof. These groups Z and Z′ may also be formed by the polymerization termination reaction.

(Precise Anionic Polymerization)

The precise anionic polymerization is a polymerization process using a anionic species as a polymerization active species. The resultant polymer has a molecular weight distribution index close to 1 (e.g., between 1 and 1.8) and is precisely controlled with respect to the number-average molecular weight by the precise cationic polymerization. The precise cationic polymerization is one of known precise ionic polymerization processes and is represented by a living anionic polymerization.

In the precise anionic polymerization in the present invention, polymerization is performed by appropriately combining a polymerization initiator, an anionic polymerizable monomer, and a polymerization terminator, shown below.

The anionic polymerizable monomer used in the present invention may be a known anionic polymerizable monomer, capable of being polymerized through the precise anionic polymerization, preferably be a vinyl monomer. Examples thereof may include: (meth-)acrylates, such as methyl (meth-)acrylate; acrylates, such as butyl acrylate; styrenes; butadiene; isoprene, acrylonitrile; (meth-)acrylonitrile; etc.

Selections of the monomers for improving the dispersibility and electric chargeability of the particles, and the additive is similar to those in the case of the above described precise cationic polymerization.

As the polymerization initiator, it is possible to use a conventionally known precise anionic polymerization initiator but in a preferred embodiment, the polymerization initiator is alkali metal, alkyl alkali, Grignard reagent, alcoholate, etc. As specific examples thereof, it is possible to use hydrogen lithium n-butylate, sodium-naphthalene, etc.

Examples of the polymerization terminator may include alcohols, water, carbon dioxide, ethylene oxide, esters, primary alkylhalide, etc. The polymerization initiator also includes the functional terminator having the functional group Z or the precursor group Z′ thereof. These groups Z and Z′ may also be formed by the polymerization termination reaction.

(Elongation Grafting)

The elongation grafting is such a grafting process that polymerization is performed by the above described precise ionic polymerization after the precise ionic polymerization initiation group is introduced onto the core particle surface to effect polymer grafting. A method for introducing the polymerization initiation group to the core particle surface may be one wherein the functional group X on the core particle surface and the functional group Y of the functional initiator are reacted with each other to be connected with each other. The combination of the functional groups X and Y is not particularly limited so long as they can be reacted and connected with each other. More specifically, the combination may be determined by appropriately selecting two functional groups from a group of functional groups shown below so that they can form covalent bond, such as ester bond, amide bond, ether bond, urethane bond, etc.

Group of functional group is: hydroxyl group, carboxyl group, carboxylic acid chloride group, sodium carboxylate, amino group, alkyl halide group, isocyanate group, epoxide group, ester group, alkali alkyl group, vinyl group, trichlorosilyl group, triethoxysilyl group.

The polymerization initiation group having the functional group Y of the functional initiator may also be the precursor group Y′ thereof during formation of bonding to the core particle. In this case, the precursor group may be converted into the polymerization initiation group after the formation of bonding. Further, in the case where the functional group X is the polymerization initiation group as it is, the reaction with the functional group Y is not required.

Then, when the above described precise cationic polymerization or precise anionic polymerization is performed in synchronism with formation of the precise ionic polymerization initiation group introduced on the core particle surface, it is possible to effect elongation grafting of a desired polymer chain.

(Implantation Grafting)

The implantation grafting is such a grafting process that a terminal functional polymer is prepared by the precise ionic polymerization in advance and is then fixed on the core particle surface by covalent bonding to effect polymer grafting. A method for fixing the terminal functional polymer on the core particle surface may be performed by reacting a functional group X on the core particle surface with a terminal functional group YZ of the terminal functional polymer to form covalent bond therebetween. The terminal functional group YZ is drive from the functional group Y or Z of the functional terminator.

The combination of the functional groups X and YZ is not particularly limited so long as they can be reacted and connected with each other. More specifically, the combination may be determined by appropriately selecting two functional groups from a group of functional groups shown below so that they can form covalent bond, such as ester bond, amide bond, ether bond, urethane bond, etc.

Group of functional group is: hydroxyl group, carboxyl group, carboxylic acid chloride group, sodium carboxylate, amino group, alkyl halide group, isocyanate group, epoxide group, ester group, aldehyde group, alkali alkyl group, vinyl group, silylenol ether group, trichlorosilyl group, triethoxysilyl group.

In the case where the functional group X is the polymerization termination group as it is, the reaction with the functional group YZ is not required since the polymer chain is subjected to the implantation grafting when the core particles are use din the polymerization termination reaction. Further, the functional group X may also be introduced to the core particle surface through a spacer. Herein, the spacer is defined as an atomic group capable of imparting mobility to a reaction point in order to lower spatial hindering property of the reaction point, thereby to enlarge a reaction area. More specifically, the spacer may be a long-chain alkyl atomic group, a polymer chain, etc. By the use of the spacer, it is possible to improve reactivity of the implantation grafting to increase a surface grafting density.

(Copolymer/Plural Species of Polymer Chains)

As the polymeric compound subjected to the grafting, it is also possible to use a copolymer is described above with respect to the feature C of the precise ionic polymerization. A specific production process of the copolymer is as described above. Further, it is also possible to effect grafting of two or more species of homopolymers at the core particle surface. Herein, the homopolymer means a polymeric compound consisting of a polymer obtained from one species of monomer.

Such a grafting of two or more species of polymer chains can be performed by, e.g., subjecting three components including the core particles having a functional group X, a homopolymer obtained from monomer 1 having a terminal functional group YZ, and a homopolymer obtained from monomer 2 having a terminal functional group YZ, to the implantation grafting. Here, the combination of the functional groups X and YZ is such a combination that they can be reacted and connected with each other. Further, the monomer 1 has a molecular structure different from that of the monomer 2.

(Electrophoretic Display Device)

As the particle movement type display apparatus to which the particles for the particle movement type display apparatus of the present invention is applicable, it is possible to use an electrophoretic display device, toner display, a magnetic display apparatus, etc Hereinbelow, an embodiment of an electrophoretic display device using electrophoretic particles of the present invention will be described with reference to the drawings.

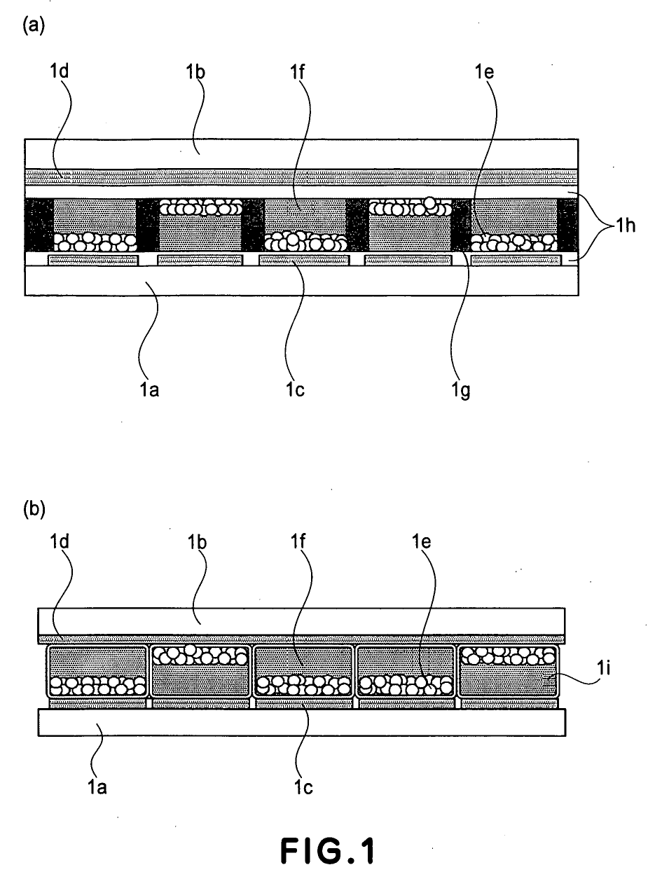

The particle(s) described with referenced to FIGS. 1(a) to 5(b) include that (those) comprising the above described composite particle to which the polymeric compound is fixed (first invention) and pigment particle itself to which the polymeric compound is fixed (second invention).

FIGS. 1(a) and 1(b) are schematic sectional views each showing an embodiment of the electrophoretic display device using the electrophotographic particles, the particles for the particle movement type display apparatus of the present invention.

As shown in FIG. 1(a), the electrophoretic display device includes a first substrate 1a provided with a first electrode 1c a second substrate 1b provided with a second electrode 1d which are disposed opposite to each other with a predetermined spacing through a partition wall 1g. In a cell (space) defined by the pair of first and second substrates 1a and 1b and the partition wall 1g, an electrophoretic particle dispersion liquid comprising at least electrophoretic particles 1e and an electrophoretic particle dispersion medium 1f is sealed. On each of the electrodes 1c and 1d, an insulating layer 1h is formed. A display surface of the electrophoretic display device is located on the second substrate 1b side. Thus, a container for containing the particle dispersion liquid is formed by the first substrate 1a, the second substrate 1b, and the partition wall 1g.

FIG. 1(b) shows an electrophoretic display device using microcapsules. On a first substrate 1a, a plurality of microcapsules 1i each containing the electrophoretic particle dispersion liquid are disposed and covered with a second substrate 1b. In the case of using the microcapsules 1i, the insulating layer 1h may be omitted.

In FIGS. 1(a) and 1(b), the first electrode 1c comprises a plurality of electrode portions as pixel electrodes capable of independently applying a desired electric field to the electrophoretic particle dispersion liquid in each cell (or each microcapsule), and the second electrode 1d is a common electrode through which the same potential is applied to the entire display area. These electrodes constitute voltage application means.

The first electrode 1c (pixel electrode) is provided with an unshown switching element (for each electrode portion) and is supplied with a selection signal from an unshown matrix drive circuit row by row and also supplied with a control signal and an output from an unshown drive transistor column by column. As a result, it is possible to apply a desired electric field to the electrophoretic particle dispersion liquid (electrophoretic particles 1e) in each of the cells.

The electrophoretic particles 1e in each individual cell (or microcapsule) are controlled by an electric field applied through the first electrode 1c, whereby at each pixel, the color (e.g., white) of the electrophoretic particles 1e and the color (e.g., blue) of the dispersion medium 1f are selectively displayed. By effecting such a drive on a pixel-by-pixel basis, it is possible to effect display of arbitrary images and characters by use of corresponding pixels.

(Constitution of Electrophoretic Display Device)

The first substrate 1a is formed of any insulating member, for supplying the electrophoretic display device, such a glass, plastic, or the like.

As the first electrode 1c, it is possible to use a (vapor-)deposition film of ITO (indium tin oxide), tin oxide, indium oxide, gold, chromium, or the like. Pattern formation of the first electrode 1c can be performed by photolithography.

The second substrate 1b may be a transparent substrate or a transparent plastic substrate.

As the second electrode 1d, it is possible to use a transparent electrode of a film of ITO or an organic conductive material.

The insulating layer 1h can be formed of a colorless transparent insulating resin, such as acrylic resin, epoxy resin, fluorine-based resin, silicone resin, polyimide resin, polystyrene resin, or polyalkene resin.

The partition wall 1g can be formed of a polymeric material through any method including, e.g., a method wherein the partition wall is formed with a photosensitive resin through the photolithographic process, a method wherein the partition wall which has been prepared in advance is bonded to the substrate, a method wherein the partition wall is formed through molding, or the like.

The method of filling the electrophoretic dispersion liquid is not particularly limited but can be an ink jet method using nozzles.

(Application to Microcapsule-Type Electrophoretic Display Device)

The microcapsule 1i containing therein the electrophoretic particle dispersion liquid described above can be prepared through a known method, such as interfacial polymerization, in situ polymerization, coacervation, or the like.

As a material for the microcapsule 1i, a high light-transmissive material may preferably be used. Examples thereof may include: urea-formaldehyde resin, melamine-formaldehyde resin, polyester, polyurethane, polyamide, polyethylene, polystyrene, polyvinyl alcohol, gelatine, their copolymers, and so on.

The method of forming the microcapsules 1i on the first substrate 1a is not particularly restricted but may be an ink jet method using nozzles.

Incidentally, in order to prevent positional deviation of the microcapsule 1i disposed on the substrate, a light-transmissive resin binder may be filled in a gap between adjacent microcapsules to fix the microcapsules on the substrate. As the resin binder, it is possible to use polyvinyl alcohol, polyurethane, polyester, acrylic resin, silicone resin, etc.

In the case of sealing a spacing between the first and second substrates 1a and 1b, the spacing may preferably be sealed under pressure so that the microcapsule 1i has such a shape that a horizontal length is longer than a vertical length with respect to the first substrate 1a (FIG. 1(b)).

(Electrophoretic Particle Dispersion Medium)

As the electrophoretic dispersion medium 1f, it is possible to use a liquid, which is high insulative and colorless and transparent, including: aliphatic hydrocarbons, such as hexane, cyclohexane, kerosine, normal paraffin, isoparaffin, etc. These may be used singly or in mixture of two or more species.

The electrophoretic particle dispersion medium 1f may be colored with oil soluble dye having a color of R (red), G (green), B (blue), C (cyan), M (magenta), Y (yellow), etc. Examples of the oil soluble dye may preferably include azo dyes, anthraquinone dyes, quinoline dyes, nitro dyes, nitroso dyes, penoline dyes, phthalocyanine dyes, metal complex salt dyes, naphthol dyes, benzoquinone dyes, cyanine dyes, indigo dyes, quinoimine dyes, etc. These may be used in combination.

Examples of the oil soluble dye may include Vari Fast Yellow (1101, 1105, 3108, 4120), Oil Yellow (105, 107, 129, 3G, GGS), Vari Fast Red (1306, 1355, 2303, 3304, 3306, 3320), Oil Pink 312, Oil Scarlet 308, Oil Violet 730, Vari Fast Blue (1501, 1603, 1605, 1607, 2606, 2610, 3405). Oil Blue (2N, BOS, 613), Macrolex Blue RR, Sumiplast Green G, Oil Green (502, BG), etc. A concentration of these dyes may preferably be 0.1-3.5 wt. %, per the electrophoretic particle dispersion medium 1f.

(Electrophoretic Particle Dispersion Liquid)

The electrophoretic particle dispersion liquid at least contain the electrophoretic particles 1e and the electrophoretic particle dispersion medium if. In order to electrically charge the electrophoretic particles 1e, it is preferable that the above described acidic additive or basic additive is added in the dispersion liquid.

### DISPLAY EXAMPLE 1

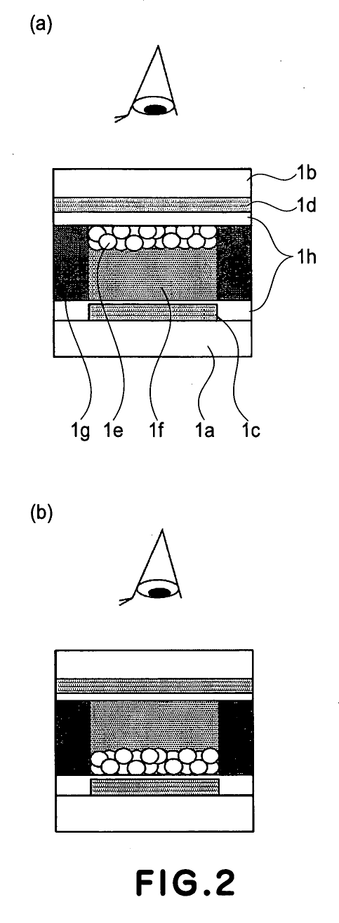

Another display example of the electrophoretic display device using the particles for the particle movement type display apparatus according to the present invention as the electrophoretic particle is shown in FIGS. 2(a) and 2(b).

FIGS. 2(a) and 2(b) illustrate a display example wherein, e.g., an electrophoretic particle dispersion liquid comprising white electrophoretic particles 1e and a blue electrophoretic particle dispersion medium 1f is filled in a cell. The electrophoretic particles 1e is negatively charged in this case.

When the electrophoretic particles 1e are collected on the surface of the second electrode 1d as shown in FIG. 2(a) by applying a negative-polarity voltage to the first electrode 1c while keeping the voltage of the second electrode 1d at 0 V, the cell looks white, attributable to the distribution of the white electrophoretic particles 1e, when viewed from above. On the other hand, when the electrophoretic particles 1e are collected on the surface of the first electrode 1c as shown in FIG. 2(b), by applying a positive-polarity voltage to the first, electrode while keeping the voltage of the second electrode 1d at 0 V, the cell looks blue when viewed from above.

### DISPLAY EXAMPLE 2

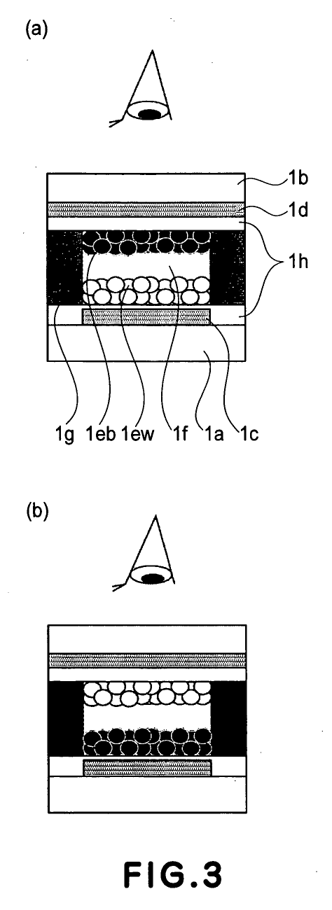

Another display example of the electrophoretic display device using the particles for the particle movement type display apparatus according to the present invention is shown in FIGS. 3(a) and 3(b).

FIGS. 3(a) and 3(b) illustrate a display example wherein, e.g., an electrophoretic particle dispersion liquid comprising positively charged white electrophoretic particles 1ew, negatively charged black electrophoretic particles 1eb, and a colorless and transparent electrophoretic particle dispersion medium 1f is filled in a cell.

When the black electrophoretic particles 1eb are collected on the surface of the second electrode 1d and the white electrophoretic particles 1ew are collected on the surface of the first electrode 1c, as shown in FIG. 3(a) by applying a negative-polarity voltage to the first electrode 1c while keeping the voltage of the second electrode 1d at 0 V, the cell looks black, attributable to the distribution of the black electrophoretic particles 1eb, when viewed from above. On the other hand, when the white electrophoretic particles 1ew are collected on the surface of the first electrode 1d and the black electrophoretic particles 1eb are collected on the surface of the first electrode 1c, as shown in FIG. 3(b), by applying a positive-polarity voltage to the first electrode while keeping the voltage of the second electrode 1d at 0 V, the cell looks white, attributable to the distribution of the white electrophoretic particles 1ew, when viewed from above.

The applied voltage varies depending on a charge amount of the electrophoretic particles and a distance between the electrodes but is required to be several volts to several ten volts, and the gradation display can be controlled by the applied voltage and an application time.

By performing such a drive on a pixel-by-pixel basis, it is possible to display an arbitrary image or character by use of a multiplicity of pixels.

(Horizontal Movement-Type Electrophoretic Display Device)

Hereinbelow, another embodiment of an electrophoretic display device using, as the electrophoretic particles, particles for the particle movement type display apparatus of the present invention will be described with reference to the drawings.

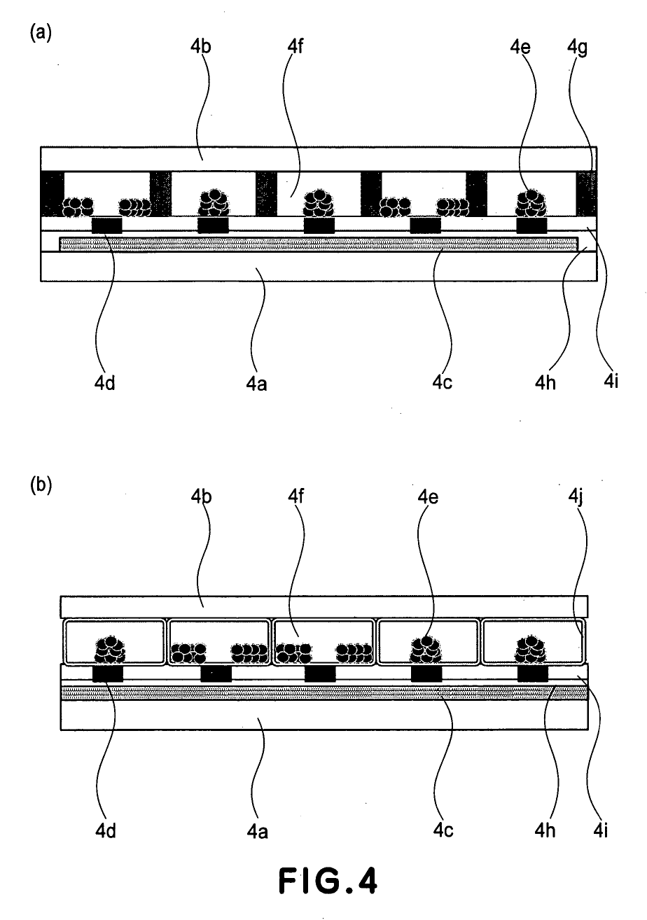

FIGS. 4(a) and 4(b) are schematic sectional views each showing another embodiment of the electrophoretic display device using, as the electrophotographic particles, particles for the particle movement type display apparatus of the present invention.

As shown in FIG. 4(a), the electrophoretic display device includes a first substrate 4a on which a first electrode 4c and a second electrode 4d are disposed. Between the electrodes 4c and 4d and on the second electrode 4d, an insulating layer 4h and an insulating layer 4i are formed, respectively. The insulating layer 4h formed between the electrodes 4c and 4d may be colored or may be colorless and transparent, but the insulating layer 4i is colorless and transparent.

The electrophoretic display device further includes a second substrate 4b disposed opposite to the first substrate 4a with a predetermined spacing through a partition wall 4g. In a cell (space) defined by the pair of first and second substrates 4a and 4b and the partition wall 4g, an electrophoretic particle dispersion liquid comprising at least electrophoretic particles 4e and an electrophoretic particle dispersion medium 4f is sealed. A display surface of the electrophoretic display device is located on the second substrate 4b side.

FIG. 4(b) shows an electrophoretic display device using microcapsules. On a first substrate 4a, a plurality of microcapsules 4i each containing the electrophoretic particle dispersion liquid are disposed and covered with a second substrate 4b. In the case of using the microcapsules 4i, the insulating layer 4i may be omitted.

In FIGS. 4(a) and 4(b), the second electrode 4d comprises a plurality of electrode portions as pixel electrodes capable of independently applying a desired electric field to the electrophoretic particle dispersion liquid in each cell (or each microcapsule), and the first electrode 4c is a common electrode through which the same potential is applied to the entire display area.

The second electrode 4d (pixel electrode) is provided with an unshown switching element (for each electrode portion) and is supplied with a selection signal from an unshown matrix drive circuit row by row and also supplied with a control signal and an output from an unshown drive transistor column by column. As a result, it is possible to apply a desired electric field to the electrophoretic dispersion liquid (electrophoretic particles 4e) in each of the cells groups.

The electrophoretic particles 4e in each individual cell (or microcapsule) are controlled by an electric field applied through the second electrode 4d, whereby at each pixel, the color (e.g., black) of the electrophoretic particles 4e and the color (e.g., white) of the insulating layer 4h are selectively displayed. By effecting such a drive on a pixel-by-pixel basis, it is possible to effect display of arbitrary images and characters by use of corresponding pixels.

(Constitution of Electrophoretic Display Device)

The first substrate 4a is formed of any insulating member, for supplying the electrophoretic display device, such a glass, plastic, or the like.

The second substrate 4b may be a transparent substrate or a transparent plastic substrate.

The first electrode 4c is a metal electrode of, e.g., Al exhibiting light reflection performance.

The insulating layer 4h formed on the first electrode 4c is formed of a mixture of a transparent colorless insulating resin with light scattering fine particles of, e.g., aluminum oxide or titanium oxide. As a material for the transparent colorless insulating resin, it is possible use the above described insulating resins. Alternatively, it is also possible to use a light scattering method utilizing unevenness at the surface of the metal electrode without using the fine particles.

The second electrode 4d is formed of an electroconductive material, which looks dark black from the viewer side of the electrophoretic display device, such as titanium carbide, black-treated Cr, and Al or Ti provided with a black surface layer. Pattern formation of the second electrode 5 may be performed through a photolithographic process.

On the second electrode 4d, the insulating layer 4i is formed of, e.g., the transparent colorless insulating resin described above.

In this embodiment, a display contrast is largely depend on an areal ratio between the second electrode 4d (each electrode portion) and an associated pixel, so that an exposed area of the second electrode 4d is required to be smaller than that of the pixel in order to enhance a contrast. For this reason, it is preferable that the areal ratio therebetween may ordinarily be 1:2 to 1:5.

The partition wall 4g may be formed in the same manner as described above. The method of filling the above described electrophoretic particle dispersion liquid in the cell is not limited particularly but may be the above described ink jet method using nozzles.

(Application to Microcapsule-Type Electrophoretic Display Device)

The microcapsule 4j containing the electrophoretic dispersion liquid can be prepared by the known method as described above, such as interfacial polymerization, in situ polymerization, coacervation, and so on. The material for forming the microcapsule 3j may be the same polymer as described above.

The method of forming the microcapsules 4j on the first substrate 4a is not particularly restricted but may be the above described ink jet method using nozzles.

Incidentally, in order to prevent positional deviation of the microcapsule 4i disposed on the substrate, a light-transmissive resin binder may be filled in a gap between adjacent microcapsules to fix the microcapsules on the substrate. As the resin binder, it is possible to use the above described resin.

In the case of sealing a spacing between the first and second substrates 4a and 4b, the spacing may preferably be sealed under pressure so that the microcapsule 4i has such a shape that a horizontal length is longer than a vertical length with respect to the first substrate 1a (FIG. 4(b)).

(Electrophoretic Particle Dispersion Medium)

As the electrophoretic particle dispersion medium 4f, it is possible to use the above described liquids.

(Electrophoretic Particles)

As the electrophoretic particles 4e, it is possible to use black particles (obtained by the same method as that described above). In this embodiment, a concentration of the electrophotographic particles 4e may preferably 0.5-10 wt. %, more preferably 1-5 wt. %, per the weight of the electrophoretic dispersion medium 4f although it varies depending on the particle size of the electrophoretic particles 4f. When the concentration of the electrophotographic particles 4e is less than 0.5 wt. %, the first electrode 4c cannot be covered completely, so that a display contrast is undesirably lowered. Further, when the concentration of the electrophotographic particles 4e exceeds 10 wt. %, the electrophotographic particles extend off the colored second electrode 4d, thus undesirably lowering the display contrast.

### DISPLAY EXAMPLE

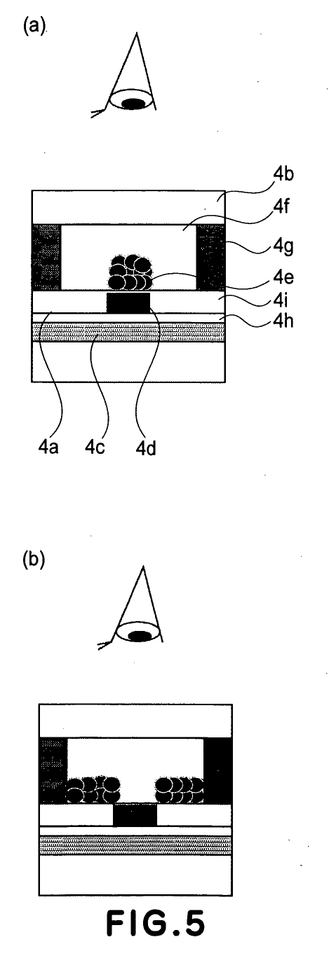

A display example of the horizontal movement-type electrophoretic display device using the particles for the particle movement type display apparatus according to the present invention as the electrophoretic particles is shown in FIGS. 5(a) and 5(b).

FIGS. 5(a) and 5(b) illustrate a display example wherein, e.g., an electrophoretic particle dispersion liquid comprising black electrophoretic particles 3e and a colorless and transparent electrophoretic particle dispersion medium 4f is filled in a cell. The electrophoretic particles 4e is negatively charged in this case.

In the case where the color of the surface of the insulating layer 4h is white and the color of the surface of the second electrode 4d is black, when the electrophoretic particles 4e are collected on the surface of the second electrode 4d as shown in FIG. 5(a) by applying a positive-polarity voltage to the second electrode while keeping the voltage of the first electrode 4c at 0 V, the cell looks white when viewed from above. On the other hand, when the electrophoretic particles 4e are collected on the surface of the first electrode 4c as shown in FIG. 5(b), by applying a negative-polarity voltage to the second electrode while keeping the voltage of the first electrode 4c at 0 V, the cell looks black when viewed from above. The applied voltage varies depending on a charge amount of the electrophoretic particles and a distance between the electrodes but is required to be several volts to several ten volts, and the gradation display can be controlled by the applied voltage and an application time.

By performing such a drive on a pixel-by-pixel basis, it is possible to display an arbitrary image or character by use of a multiplicity of pixels.

Hereinbelow, action and effect of the present invention will be described more specifically.

As described above, the particles used in the particle movement type display apparatus is required to be excellent in electrical charge stability and have a good dispersibility.

A part of charging mechanism has not been clarified as yet but can be considered as described below.

Negative or positive electrical chargeability is imparted to the particles by introducing an acidic or basic structure into the polymer coating layer (polymeric compound) and combining the resultant layer (compound) with a basic or acidic additive to cause acid-base interaction therebetween.

Further, giving and receiving of electric charge are performed between the particles and various materials located close to the particles due to contact and friction therebetween, thereby to impart the electrical chargeability to the particles in some cases. In these cases, a direction and a degree of giving and receiving of electric charge are largely affected by the structure of the polymer coating layer with respect to the particles.

In either case, it is considered that the number of structural units (e.g., acidic unit, basic unit, units different in electronegativity, etc.) contributing to electrical charging with respect to the polymer coating layer largely affects an amount of charge of the particles.

Accordingly, it is considered that an irregularity in particle charge amount can be suppressed by precisely controlling the structure of the polymer coating layer.

Further, when fine particles contact each other, Van der Waals attraction acts between the particles to cause agglomeration of the particles. In order to prevent this agglomeration, e.g., it is considered that adjustment of a distance between particles by providing a steric hindrance group at the particle surface is effective means. In this case, the distance between particles is determined depending on a thickness at the polymer coating layer, so that an occurrence of an irregularity in thickness of the polymer coating layer manifests itself as an irregularity in particle dispersibility.

Accordingly, it is considered that particles improved in dispersibility can be obtained by providing a coating layer of a polymer, with a precisely controlled structure as described in the present invention, to the particles.

Hereinbelow, the second invention will be described.

In the second invention, the particles for the particle movement type display apparatus can be prepared through the following two processes (1) and (2):

(1) Elongation grafting comprising a step of introducing a precise ionic polymerization initiation group onto the surface of pigment particle and a step of subjecting a polymeric compound to grafting from the precise ionic polymerization initiation group, and

(2) Implantation grafting comprising a step of introducing a reactive functional group X onto the surface of pigment particle, a step of preparing a polymeric compound having a reactive functional group Y through the precise ionic polymerization, and a step of forming covalent bond by reacting the reaction functional group X with the reaction functional group Y.

(Elongation Grafting)

As described above, in the elongation grafting, the precise ionic polymerization initiation group is introduced to the pigment particle surface in advance and then the polymeric compound is subjected to grafting from the precise ionic polymerization initiation group through the precise ionic polymerization.

In order to introduce the polymerization initiation group to the pigment particle surface, it is possible to effect the introduction by reacting the reactive functional group X on the pigment particle surface with a polymerization initiator having a functional group Z which has reactive activity with respect to the reactive functional group X.

The reactive functional group X is not particularly limited. For example, it has been known that hydroxyl group or carboxyl group is present at a surface of particle of carbon black which is preferably used as a black pigment and that hydroxyl group is present at a surface of particle of titanium oxide which is preferably used as a white pigment. It is possible to utilize these functional groups.

Further, the reactive functional group Z is also not particularly limited. For example, a group having reactive activity with respect to hydroxyl group may be carboxylic acid chloride group capable of forming ester bond by directly reacting with hydroxyl group or may be isocyanate group capable of forming urethane bond by directly reacting with hydroxyl group.

The functional group Z also includes carboxyl group or the like capable of forming ester group in the presence of a dehydration condensation agent. Examples thereof may include dicyclohexyl carbodiimide (DCC), 1-ethyl-3-(3-dimethylaminopropyl)-carbodiimide (hereinafter referred to as “WSC”), their hydrochlorides, etc.

Further, a group having reactive activity with respect to carboxyl group may be isocyanate group or the like capable of forming amide bond by directly reacting with carboxyl group or may be amino group capable of forming amide bond or hydroxyl group or the like capable of forming ester bond, in the presence of the dehydration condensation agent such as DCC or WSC.

Incidentally, in the case of the direct reactions described above, it is also possible to add an additive for increasing a reaction speed.

Further, the introduction of the polymerization initiation group can also be performed by converting the reactive functional group X on the pigment particle surface into a different reactive functional group X1 in advance and then reacting the functional group X1 with a polymerization initiator having a functional group Z1 which has reactive activity with respect to the functional group X1.

Further, in the case where the reactive functional group X on the pigment particle surface functions as the polymerization initiator, it is possible to subject the polymeric compound to grafting from the functional group X directly through the precise ionic polymerization.

(Implantation Grafting)

In the implantation grafting, a polymeric compound having a functional group Y which has reactive activity with respect to the reactive functional group X on the pigment particle surface is prepared in advance by the precise ionic polymerization and then is reacted with pigment particle to fix the polymeric compound to the surface of pigment particle by covalent bonding.

The polymeric compound having the functional group Y may be prepared by performing the precise ionic polymerization with the functional group Y or a precise ionic polymerization initiation group having a precursor of the functional group Y to provide the polymeric compound with a desired molecular weight.

Further, particularly, the precise ionic polymerization is performed by using an ordinary precise ionic polymerization initiation group having no reactive functional group and then as a therminator, a compound having the functional group Y or a precursor thereof is used to prepare the polymeric compound.

Further, it is also possible to introduce a plurality of functional groups Y into the polymeric compound by using a polymerizable monomer having the functional group Y or a precursor thereof.

However, from the viewpoint of capability of strict control of a bonding state of the polymeric compound at the pigment particle surface, it is preferable that the precise ionic polymerization initiation group or the compound, as the terminator, having the functional group Y or the precursor thereof.

Further, the reactive functional group X on the pigment particle surface may be connected with the pigment particle through a spacer.

In the implantation grafting, a graft degree is suppressed in some cases by blocking an unreacted reactive functional group X on the surface of pigment particle with the polymeric compound which has been connected with the pigment particle surface in advance.

In the case where the reactive functional group X is connected to the pigment particle surface via the spacer, the functional group X is present in a reaction system in such an exposed state that it avoids blocking by the polymeric compound, so that it becomes possible to suppress a lowering in graft degree.

Incidentally, the spacer referred to herein means a compound for providing a distance between the reaction functional group X and the pigment particle surface and a structure thereof is not particularly limited. As the spacer, e.g., a long-chain alkylene or the like can be used.

(Precise Cationic Polymerization)

The precise cationic polymerization is a polymerization process using a cationic species as a polymerization active species. The resultant polymer has a molecular weight distribution index (weight-average molecular weight/number-average molecular weight) of not more than 1.8, preferably not more than 1.5, and is precisely controlled with respect to the number-average molecular weight by the precise cationic polymerization. The precise cationic polymerization is one of known precise ionic polymerization processes and is represented by a living cationic polymerization.

In the precise cationic polymerization in the present invention, polymerization is performed by appropriately combining a polymerization initiator, a cationic polymerizable monomer, Lewis acid polymerization catalyst, an additive, and a polymerization terminator, shown below.

The cationic polymerizable monomer used in the present invention may be those, such as methyl vinyl ether, described in the above mentioned first invention.

Particularly, it is desirable in view of an improvement in dispersibility of the particles that the monomer is selected so that it provides a polymer having a high affinity for an electrophoretic particle dispersion medium. When the polymer chain has a high affinity for the dispersion medium, the polymer chain has an expanse in the electrophoretic particle dispersion medium, thus capable of effectively functioning as a steric hindrance group for preventing agglomeration between particles. Incidentally, herein, the high affinity means that the polymer chain and the electrophoretic particle dispersion medium are excellent in mutual solubility without causing phase separation.

Further, it is desirable in terms of an improvement in electrical chargeability of particles that a monomer having a unit which has a electronegativity different largely from those of the electrophoretic particle dispersion medium and the additive, such as an acidic unit or a basic unit, as the polymerizable monomer is selected.

By combining the resultant acidic or basic polymer with a basic or acidic additive, acid-base interaction between the polymer and the additive is caused to occur, so that it is possible to effectively impart electric chargeability to the particles.

As the polymerization initiator, the Lewis acid polymerization catalyst, and the additive, it is possible to use those described in the first invention.

Examples of the polymerization terminator may include alcohols, water, sodium diethylmalonate, sodium alkoxides, sylylenol ethers, Grignard reagent, etc. The polymerization initiator also includes a functional terminator having a functional group Z or a precursor group Z′ thereof. These groups Z and Z′ may also be formed by the polymerization termination reaction.

(Precise Anionic Polymerization)

The precise cationic polymerization is a polymerization process using an anionic species as a polymerization active species. The resultant polymer has a molecular weight distribution index (weight-average molecular weight/number-average molecular weight) of not more than 1.8, preferably not more than 1.5, and is precisely controlled with respect to the number-average molecular weight by the precise anionic polymerization. The precise anionic polymerization is one of known precise ionic polymerization processes and is represented by a living anionic polymerization.

In the precise anionic polymerization in the present invention, polymerization is performed by appropriately combining a polymerization initiator, a anionic polymerizable monomer, and a polymerization terminator, shown below.

The cationic polymerizable monomer used in the present invention may be those described above.

Particularly, it is desirable in view of an improvement in dispersibility of the particles that the monomer is selected so that it provides a polymer having a high affinity for an electrophoretic particle dispersion medium. When the polymer chain has a high affinity for the dispersion medium, the polymer chain has an expanse in the electrophoretic particle dispersion medium, thus capable of effectively functioning as a steric hindrance group for preventing agglomeration between particles. Incidentally, herein, the high affinity means that the polymer chain and the electrophoretic particle dispersion medium are excellent in mutual solubility without causing phase separation.

Further, it is desirable in terms of an improvement in electrical chargeability of particles that a monomer having a unit which has a electronegativity different largely from those of the electrophoretic particle dispersion medium and the additive, such as an acidic unit or a basic unit, as the polymerizable monomer is selected.

By combining the resultant acidic or basic polymer with a basic or acidic additive, acid-base interaction between the polymer and the additive is caused to occur, so that it is possible to effectively impart electric chargeability to the particles.

As the polymerization initiator, and the polymerization terminator, it is possible to use those described above.

(Graft Chain)

A number-average molecular weight of the polymer chain can be appropriately determined. For example, in the case where the polymer chain is of a dispersion function type, the number-average molecular weight may preferably 500-1,000,000, more preferably 1,000-500,000. When the polymer chain has the number-average molecular weight of less than 500, it is difficult to ensure the dispersion function. On the other hand, when the number-average molecular weight exceeds 1,000,000, a solubility of the polymer chain in the electrophoretic particle dispersion medium is undesirably lowered.

(Pigment)

As the pigment particles constituting the core particles of the electrophoretic particles, it is possible to use those described in the first invention.

The pigment particles may preferably have an average particle size of 10 nm to 2 μm, more preferably 200 nm to 1 μm. Below 10 nm, handling performance is considerably lowered undesirably. Further, above 2 μm, a coloring degree (definition) of the pigment particles is undesirably lowered.

The electrophoretic particles in the second invention are also applicable to the display apparatus similarly as in those in the first invention.

Hereinbelow, the present invention will be described more specifically based on Examples but is not limited thereto. The first invention is described based on Examples 1-12, and the second invention is described based on Examples 13-20.

Core particles (colorant:titanium oxide) having hydroxyl group at each particle surface is reacted with 2-chloroethyl vinyl ether in dimethyl sulfoxide in the presence of sodium hydroxide. After washing and drying steps, hydrogen chloride is add into the reaction mixture so as to form an adduct of vinyloxy group (site), whereby core particles 1 of a polymerization initiation group carrying-type wherein a living cationic polymerization initiation group represented by a formula (1) shown below is introduced onto the surface of each particle are obtained.

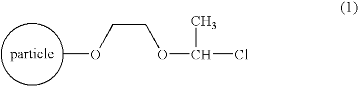

To the above prepared core particles 1, isobutyl ether, tin tetrachloride, and N-tetra-n-butylammonium chloride are added, followed by living cationic polymerization in dichloromethane (solvent) for a predetermined time at −78° C.

Further, as an index of a molecular weight and a molecular weight distribution of a polymer chain to be subjected to grafting of core particle, isobutyl vinyl ether hydrogen chloride adduct (IBVE-HCl), which is represented by a formula (2) shown below and used as a polymerization initiator species which is not fixed to the core particles, is added into the reaction system in advance.

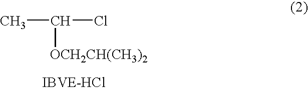

After the polymerization, the resultant particles are washed and dried to obtain objective particles for a particle movement type display apparatus. An average particle size of the particles is about 2.7 μm.

The thus obtained particles are well dispersed in tetrahydrofuran (THF), so that it is possible to confirm that poly(isobutyl vinyl ether) is elongation-grafted at the core particle surface. Further, when a polymer obtained from IBVE-HCl added as the polymerization initiation species which is not fixed to the core particles is subjected to measurement of molecular weight and molecular weight distribution, the polymer has a number-average molecular weight of about 20,000 and a molecular weight dispersion index (weight-average molecular weight/number-average molecular weight) of 1.08. As a result, it is possible to confirm that the polymer chains elongation-grafted to the core particles have a uniform chain length.

The above prepared particles for the particle movement type display apparatus are used as electrophoretic particles in the following manner. An electrophoretic particle dispersion liquid is prepared by using 5 wt. % of the core particles as electrophoretic particles (white particles), 0.1 wt. % of a colorant (“Oil Blue N”, mfd. by Aldrich Co.), 2.5 wt. % of rosin acid (acidic additive), and 92.4 wt. % of an electrophoretic particle dispersion medium (“Isoper H, mfd. by Exxon Corp.). The electrophoretic particles are positively charged by acid-base interaction between the grafted poly(isobutyl vinyl ether) and rosin acid. Further, the grafted poly(isobutyl vinyl ether) has an expanse in the electrophoretic dispersion medium, thus having also a dispersion function.

The electrophoretic particle dispersion liquid is injected into a cell by using nozzles according to an ink jet method to provide an electrophoretic display device, as shown in FIG. 1(a), which is connected with a voltage application circuit.

When the resultant electrophoretic display device is subjected to contrast display for a long time by driving it at a drive voltage of ±10V, the electrophoretic particles are excellent in dispersibility, chargeability, and definition, and it is possible to effect clear blue/white display.

### EXAMPLE 2

A plurality of microcapsules 1i each containing an electrophoretic particle dispersion liquid prepared in the same manner as in Example 1 are prepared by in-situ polymerization method. Each microcapsule is formed of urea-formaldehyde resin as a film-forming material. An electrophoretic display device, as shown in FIG. 1(b), which is connected with a voltage application circuit is prepared by disposing the plurality of microcapsules 1i on a first substrate 1a by use of nozzles according to the ink jet method.

When the resultant electrophoretic display device is subjected to contrast display for a long time by driving it at a drive voltage of ±10V, the electrophoretic particles are excellent in dispersibility and chargeability, and it is possible to effect clear blue/white display.

### EXAMPLE 3

2-acetoxyethyl vinyl ether acetic acid adduct (AcOVE-HOAc) represented by a formula (3) shown below is used as a functional initiator. To this functional initiator, isobutyl vinyl ether, dodecyl vinyl ether (2 equivalents with respect to isobutyl vinyl ether), ethylaluminum dichloride, and ethyl acetate are added. When the mixture is subjected to living cationic polymerization in hexane for a predetermined time at 0° C., a random copolymer, of isobutyl vinyl ether having a terminal acetoxy group with dodecyl vinyl ether, having a number-average molecular weight of about 20,000 and a molecular weight dispersion index of 1.10 is obtained.

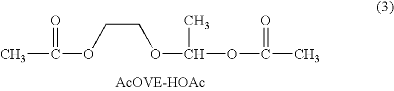

By subsequent treatment in an alkaline condition, the terminal acetoxy group is protected by hydroxyl group from elimination thereof. As a result, a random copolymer of isobutyl vinyl ether having a terminal hydroxyl group with dodecyl vinyl ether is obtained.

The thus obtained random copolymer is reacted in hexane with core particles (colorant: carbon black) having isocyanate group at each particle surface.

After the reaction, the resultant particles are washed and dried to obtain objective particles for a particle movement type display apparatus. An average particle size of the particles is about 2.8 μm.

The thus obtained particles are well dispersed in hexane, so that it is possible to confirm that the random copolymer of isobutyl vinyl ether and dodecyl vinyl ether with a uniform polymer chain length implantation-grafted at the core particle surface.

The above prepared particles for the particle movement type display apparatus are used as electrophoretic particles 4e in the following manner. An electrophoretic particle dispersion liquid is prepared by using 1 wt. % of the core particles as electrophoretic particles (particles), 0.5 wt. % of rosin acid (acidic additive), and 98.5 wt. % of an electrophoretic particle dispersion medium 4f (“Isoper H, mfd. by Exxon Corp.).

The electrophoretic particle dispersion liquid is injected into a cell by using nozzles according to an ink jet method to provide an electrophoretic display device, as shown in FIG. 4(a), which is connected with a voltage application circuit.

When the resultant electrophoretic display device is subjected to contrast display for a long time by driving it at a drive voltage of ±10V, the electrophoretic particles 4e are excellent in dispersibility and chargeability, and it is possible to effect clear white/black display.

### EXAMPLE 4

A plurality of microcapsules 4j each containing an electrophoretic particle dispersion liquid prepared in the same manner as in Example 3 are prepared by interfacial polymerization method. Each microcapsule is formed of polyamide resin as a film-forming material. An electrophoretic display device, as shown in FIG. 4(b), which is connected with a voltage application circuit is prepared by disposing the plurality of microcapsules 4j on a first substrate 4a by use of nozzles according to the ink jet method.

When the resultant electrophoretic display device is subjected to contrast display for a long time by driving it at a drive voltage of ±10V, the electrophoretic particles are excellent in dispersibility and chargeability, and it is possible to effect clear white/black display.

### EXAMPLE 5

Core particles (colorant:oil black HBB) having diphenylethylene group at each particle surface is surface-treated with n-butyllithium, whereby core particles 2 of a polymerization initiation group carrying-type wherein an anionic polymerization initiation group represented by a formula (4) shown below is introduced onto the surface of each particle are obtained.

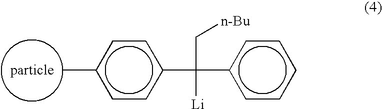

After the above prepared core particles 2 are dispersed in heptane, isoprene is added, followed by by living anionic polymerization for a predetermined time at 45° C.

After the polymerization, the resultant particles are washed and dried to obtain objective particles for a particle movement type display apparatus. An average particle size of the particles is about 1.9 μm.

The thus obtained particles are well dispersed in tetrahydrofuran (THF), so that it is possible to confirm that polyisoprene is grafted at the core particle surface. Further, when a polymer obtained from n-butyllithium remaining in the step of preparing core particles to which the anionic polymerization initiation group is introduced at each core particle surface is subjected to measurement of molecular weight and molecular weight distribution, the polymer has a number-average molecular weight of about 10,000 and a molecular weight dispersion index of 1.05. As a result, it is possible to confirm that the polymer chains grafted to the core particles have a uniform chain length.

The above prepared particles for the particle movement type display apparatus are used as electrophoretic particles in the following manner. An electrophoretic particle dispersion liquid is prepared by using 1 wt. % of the core particles as electrophoretic particles 4e (black particles), 0.5 wt. % of polyisobutylene succinimide (basic additive), and 98.5 wt. % of an electrophoretic particle dispersion medium (“Isoper H, mfd. by Exxon Corp.).

The electrophoretic particle dispersion liquid is injected into a cell by using nozzles according to an ink jet method to provide an electrophoretic display device, as shown in FIG. 4(a), which is connected with a voltage application circuit.

When the resultant electrophoretic display device is subjected to contrast display for a long time by driving it at a drive voltage of ±10V, the electrophoretic particles are excellent in dispersibility, and it is possible to effect clear white/black display.

### EXAMPLE 6

A plurality of microcapsules 4j each containing an electrophoretic particle dispersion liquid prepared in the same manner as in Example 5 are prepared by interfacial polymerization method. Each microcapsule is formed of polyamide resin as a film-forming material. An electrophoretic display device, as shown in FIG. 4(b), which is connected with a voltage application circuit is prepared by disposing the plurality of microcapsules 4j on a first substrate 4a by use of nozzles according to the ink jet method.

When the resultant electrophoretic display device is subjected to contrast display for a long time by driving it at a drive voltage of ±10V, the electrophoretic particles are excellent in dispersibility, and it is possible to effect clear white/black display.

### EXAMPLE 7

Living anionic polymerization of butadiene is performed in benzene (solvent) at 50° C. by using n-butyllithium as a polymerization initiator and styrene is added at the time of completion of the polymerization of butadiene, followed by continuation of the polymerization. The resultant polymerization solution is added into a benzene solution in which core particles (colorant: carbon black) having hydroxyl group at each core particle surface to terminate the polymerization at the core particle surface.

After the polymerization, the resultant particles are washed and dried to obtain objective particles for a particle movement type display apparatus. An average particle size of the particles is about 2.2 μm.

The thus obtained particles are well dispersed in benzene, so that it is possible to confirm that a block copolymer of polybutadiene and polystyrene is grafted at the core particle surface. A copolymer unreacted with the core particle surface has a number-average molecular weight of about 30,000 and a molecular weight dispersion index of 1.15. As a result, it is possible to confirm that the copolymer chains grafted to the core particles have a uniform chain length.

The above prepared particles for the particle movement type display apparatus are used as electrophoretic particles in the following manner. An electrophoretic particle dispersion liquid is prepared by using 1 wt. % of the core particles as electrophoretic particles 4e (black particles), 0.5 wt. % of rosin acid (acidic additive), and 98.5 wt. t of an electrophoretic particle dispersion medium (“Isoper H, mfd. by Exxon Corp.).

The electrophoretic particle dispersion liquid is injected into a cell by using nozzles according to an ink jet method to provide an electrophoretic display device, as shown in FIG. 4(a), which is connected with a voltage application circuit.

When the resultant electrophoretic display device is subjected to contrast display for a long time by driving it at a drive voltage of ±10V, the electrophoretic particles are excellent in dispersibility, and it is possible to effect clear white/black display.

### EXAMPLE 8

A plurality of microcapsules 4j each containing an electrophoretic particle dispersion liquid prepared in the same manner as in Example 7 are prepared by in-situ polymerization method. Each microcapsule is formed of melamine-formaldehyde resin as a film-forming material. An electrophoretic display device, as shown in FIG. 4(b), which is connected with a voltage application circuit is prepared by disposing the plurality of microcapsules 4j on a first substrate 4a by use of nozzles according to the ink jet method.

When the resultant electrophoretic display device is subjected to contrast display for a long time by driving it at a drive voltage of ±10V, the electrophoretic particles are excellent in dispersibility, and it is possible to effect clear white/black display.

### EXAMPLE 9

In dichloromethane, living cationic polymerization is performed for a predetermined time at −40° C. by using octadecyl vinyl ether, a functional polymerization initiator having a phthalimide group represented by a formula (5) shown below (ImVe-HCl), and zinc dichloride.

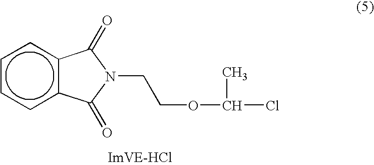

As a result, poly(octadecyl vinyl ether) having a terminal phthalimide group is obtained.

The thus obtained poly(octadecyl vinyl ether) is subjected to hydrolysis treatment to protect the terminal phthalimide group with amino group from elimination, thus preparing poly(octadecyl vinyl ether) which has a terminal amino group, a number-average molecular weight of about 20,000 and a molecular weight distribution index of 1.12.

Separately, in a similar manner, poly(2-chloroethyl vinyl ether) which has a terminal amino group, a number-average molecular weight of about 20,000, and a molecular weight distribution index of 1.07 is obtained.

Then, in hexane, the above prepared two types of the terminal amino group-containing polymers are reacted with a spacer introduction-type core particles 3 (colorant: carbon black), represented by a formula (6) shown below, having carboxyl group through a spacer at each core surface.

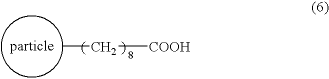

After the reaction, the resultant particles are washed and dried to obtain objective particles for a particle movement type display apparatus. An average particle size of the particles is about 2.5 μm.

The thus obtained particles are well dispersed in chloroform, so that it is possible to confirm that poly(octadecyl vinyl ether) and poly(2-chloroethyl vinyl ether) each of which has a uniform polymer chain length are grafted at the core particle surface.

The above prepared particles for the particle movement type display apparatus are used as electrophoretic particles 4e in the following manner. An electrophoretic particle dispersion liquid is prepared by using 1 wt. % of the core particles as electrophoretic particles (particles), 0.5 wt. % of rosin acid (acidic additive), and 98.5 wt. % of an electrophoretic particle dispersion medium 4f (“Isoper H, mfd. by Exxon Corp.).

The electrophoretic particle dispersion liquid is injected into a cell by using nozzles according to an ink jet method to provide an electrophoretic display device, as shown in FIG. 4(a), which is connected with a voltage application circuit.

When the resultant electrophoretic display device is subjected to contrast display for a long time by driving it at a drive voltage of ±10V, the electrophoretic particles 4e are excellent in dispersibility and chargeability, and it is possible to effect clear white/black display.

### EXAMPLE 10

A plurality of microcapsules 4j each containing an electrophoretic particle dispersion liquid prepared in the same manner as in Example 9 are prepared by interfacial polymerization method. Each microcapsule is formed of polyamide resin as a film-forming material. An electrophoretic display device, as shown in FIG. 4(b), which is connected with a voltage application circuit is prepared by disposing the plurality of microcapsules 4j on a first substrate 4a by use of nozzles according to the ink jet method.

When the resultant electrophoretic display device is subjected to contrast display for a long time by driving it at a drive voltage of ±10V, the electrophoretic particles are excellent in dispersibility and chargeability, and it is possible to effect clear white/black display.

### EXAMPLE 11

An electrophoretic particle dispersion liquid is prepared by using 5 wt. % of electrophoretic particles (white particles) obtained in the same manner as in Example 1, 2.5 wt. % of rosin acid (acidic additive), 3 wt. % of electrophoretic particles (black particles) obtained in the same manner as in Example 5, 1.5 wt. % of polyisobutylene succinimide (basic additive), and 88 wt. % of an electrophoretic particle dispersion medium (“Isopar H”, mfd. by Exxon Corp.).

The electrophoretic particle dispersion liquid is injected into a cell by using nozzles according to an ink jet method to provide an electrophoretic display device, as shown in FIG. 1(a), which is connected with a voltage application circuit.

When the resultant electrophoretic display device is subjected to contrast display for (FIG. 3) a long time by driving it at a drive voltage of ±10V, the two types of electrophoretic particles are excellent in dispersibility and chargeability, and it is possible to effect clear white/black display.

### EXAMPLE 12

A plurality of microcapsules 1i each containing an electrophoretic dispersion liquid prepared in the same manner as in Example 11 are prepared by in-situ polymerization method. Each microcapsule is formed of melamine-formaldehyde resin as a film-forming material. An electrophoretic display device, as shown in FIG. 1(b), which is connected with a voltage application circuit is prepared by disposing the plurality of microcapsules 1i on a first substrate 1a by use of nozzles according to the ink jet method.

When the resultant electrophoretic display device is subjected to contrast display (FIG. 5) for a long time by driving it at a drive voltage of ±10V, the two types of electrophoretic particles are excellent in dispersibility and chargeability, and it is possible to effect clear white/black display.

### EXAMPLE 13

Carbon black (“Color Black FW 200”, mfd. by Degussa AG) is dispersed in dehydrated DMF and then is reacted with tolylene diisocyanate in the presence of hexacarbonylmolybdenum catalyst to prepare carbon black having isocyanate group at a surface thereof.

Then, the thus prepared carbon black is again dispersed in dehydrated DMF and then is reacted with 4-hydroxybutyl vinyl ether, followed by washing and drying. Thereafter, hydrogen chloride is added to vinyloxy group (site) of the reaction product to obtain a polymerization initiation group carrying-type pigment particles to which a living cationic polymerizable group is introduced at each pigment particle surface.

To the pigment particles, dodecyl vinyl ether, tin tetrachloride, and N-tetra-n-butylammonium chloride are added, followed by living cationic polymerization in dichloromethane (solvent) for a predetermined time at −78° C.

Further, dodecyl vinyl ether hydrogen chloride adduct as a polymerization initiator species which is not fixed on the pigment particle surface is added in the reaction system in advance so as to provide an index of molecular weight and molecular weight distribution of a polymer chain grafted to the carbon black particle surface.

After the polymerization, the resultant particles are washed and dried to provide objective particles for a particle movement type display apparatus, which have an average particle size of about 0.15 μm.

The particles for the particle movement type display apparatus are well dispersed in THF, so that it is possible to confirm that poly(dodecyl vinyl ether) is elongation-grafted at the pigment particle surface. Further, when a polymer obtained from the dodecyl vinyl ether hydrogen chloride adduct added as the polymerization initiation species which his not fixed to the pigment particle surface is subjected to measurement of molecular weight and molecular weight distribution, the polymer has a number-average molecular weight of about 15,000 and a molecular weight dispersion index of 1.21. As a result, it is possible to confirm that the polymer chains elongation-grafted to the pigment particles have a uniform chain length. The thus prepared particles for the particle movement type display apparatus are used as electrophoretic particles.

An electrophoretic dispersion liquid is prepared by using 5 wt. % of the electrophoretic particles (black pigment particles), 2.5 wt. % of rosin acid ester (acidic additive), and 92.3 wt. % of an electrophoretic particle dispersion medium (“Isoper H, mfd. by Exxon Corp.). The electrophoretic particles to which poly(dodecyl vinyl ether) is grafted are positively charged. Further, the grafted poly(dodecyl vinyl ether) has an expanse in the electrophoretic particle dispersion medium, thus having also a dispersion function.

The electrophoretic particle dispersion liquid is injected into a cell by using nozzles according to an ink jet method to provide an electrophoretic display device, as shown in FIG. 4(a), which is connected with a voltage application circuit.

When the resultant electrophoretic display device is subjected to display by driving it at a drive voltage of ±15V, the electrophoretic particles are excellent in dispersibility, chargeability, and definition, and it is possible to effect clear white/black display.

### EXAMPLE 14

A plurality of microcapsules 4i each containing an electrophoretic dispersion liquid prepared in the same manner as in Example 13 are prepared by in-situ polymerization method. Each microcapsule is formed of urea-formaldehyde resin as a film-forming material. An electrophoretic display device, as shown in FIG. 4(b), which is connected with a voltage application circuit is prepared by disposing the plurality of microcapsules 4i on a first substrate 4a by use of nozzles according to the ink jet method.

When the resultant electrophoretic display device is subjected to display by driving it at a drive voltage of ±15V, the electrophoretic particles are excellent in dispersibility and chargeability, and it is possible to effect clear white/black display.

### EXAMPLE 15

Living cationic polymerization is performed in hexane (solvent) with 2-acetoxyethoxy vinyl ether acetic acid adduct as a polymerization initiator for a predetermined time at 0° C. by using n-butyl vinyl ether, ethylaluminum dichloride, and ethyl acetate.

At the time of completion of polymerization of n-butyl vinyl ether, octadecyl vinyl ether (in an amount equivalent to n-butyl vinyl ether) is added, followed by continuation of the polymerization. As a result, a block copolymer, of n-butyl vinyl ether and octadecyl vinyl ether, having a terminal hydroxyl group is obtained.

By treating the block copolymer in an alkaline condition, the terminal acetoxy group is protected by hydroxyl group from elimination thereof. As a result, a block copolymer, of n-butyl vinyl ether and octadecyl vinyl ether, having a terminal hydroxyl group is obtained.

The thus obtained block copolymer is reacted in hexane with particles of carbon black (“Color Black FW 200”, mfd. by Degussa AG) having isocyanate group at each particle surface by treating the particles with tolylene diisocyanate in the same manner as in Example 13.

After the reaction, the resultant particles are washed and dried to obtain objective particles for a particle movement type display apparatus. An average particle size of the particles is about 0.13 μm.

Further, a number-average molecular weight and a molecular weight distribution of a block copolymer which is unreacted with the particle surface of carbon black are measured. As a result, the number-average molecular weight is about 25,000 and a molecular weight distribution index is 1.25, so that it is confirmed that the polymer chains of the block copolymer grafted to the pigment particle surface have a uniform polymer chain length.

The thus obtained particles are well dispersed in hexane, so that it is possible to confirm that the block copolymer of n-butyl vinyl ether and octadecyl vinyl ether with a uniform polymer chain length implantation-grafted at the pigment particle surface.

The above prepared particles for the particle movement type display apparatus are used as electrophoretic particles in the following manner. An electrophoretic particle dispersion liquid is prepared by using 5 wt. % of the electrophoretic particles (black pigment particles), 0.3 wt. % of rosin acid ester, and 92 wt. % of an electrophoretic particle dispersion medium (“Isoper H, mfd. by Exxon Corp.). The electrophoretic particles to which the block copolymer of n-butyl vinyl ether and acetadecyl vinyl ether is grafted are positively charged.

The electrophoretic particle dispersion liquid is injected into a cell by using nozzles according to an ink jet method to provide an electrophoretic display device, as shown in FIG. 4(a), which is connected with a voltage application circuit.

When the resultant electrophoretic display device is subjected to contrast display for a long time by driving it at a drive voltage of ±10V, the electrophoretic particles are excellent in dispersibility and chargeability, and it is possible to effect clear white/black display.

### EXAMPLE 16

A plurality of microcapsules 4j each containing an electrophoretic particle dispersion liquid prepared in the same manner as in Example 15 are prepared by interfacial polymerization method. Each microcapsule is formed of polyamide resin as a film-forming material. An electrophoretic display device, as shown in FIG. 4(b), which is connected with a voltage application circuit is prepared by disposing the plurality of microcapsules 4j on a first substrate 4a by use of nozzles according to the ink jet method.

When the resultant electrophoretic display device is subjected to contrast display for a long time by driving it at a drive voltage of ±10V, the electrophoretic particles 4e are excellent in dispersibility and chargeability, and it is possible to effect clear white/black display.

### EXAMPLE 17

Living anionic polymerization of butadiene is performed in benzene (solvent) at 25° C. by using n-butyllithium as a polymerization initiator. The resultant polymerization solution is added into a benzene solution in which titanium oxide pigment particles having hydroxyl group at each core particle surface to terminate the polymerization at the pigment particle surface.

After the polymerization, the resultant particles are washed and dried to obtain objective particles for a particle movement type display apparatus. An average particle size of the particles is about 0.3 μm.

The thus obtained particles are well dispersed in chloroform, so that it is possible to confirm that polybutadiene is grafted at the pigment particle surface. A polymer unreacted with the pigment particle surface has a number-average molecular weight of about 30,000 and a molecular weight dispersion index of 1.13. As a result, it is possible to confirm that the copolymer chains grafted to the pigment particles have a uniform chain length.

The above prepared particles for the particle movement type display apparatus are used as electrophoretic particles 1e in the following manner. An electrophoretic particle dispersion liquid is prepared by using 8 wt. % of the electrophoretic particles 1e (white pigment particles), 2 wt. % of rosin acid (0.1 wt. % of a colorant ester), and 89.9 wt. % of an electrophoretic particle dispersion medium (“Isoper H, mfd. by Exxon Corp.).

The electrophoretic particles to which polybutadiene is grafted are positively charged.

The electrophoretic particle dispersion liquid is injected into a cell by using nozzles according to an ink jet method to provide an electrophoretic display device, as shown in FIG. 1(a), which is connected with a voltage application circuit.

When the resultant electrophoretic display device is subjected to contrast display for a long time by driving it at a drive voltage of ±10V, the electrophoretic particles 1e are excellent in dispersibility, and it is possible to effect clear blue/white display.

### EXAMPLE 18

A plurality of microcapsules 1j each containing an electrophoretic particle dispersion liquid prepared in the same manner as in Example 17 are prepared by in-situ polymerization method. Each microcapsule is formed of melamine-formaldehyde resin as a film-forming material. An electrophoretic display device, as shown in FIG. 1(b), which is connected with a voltage application circuit is prepared by disposing the plurality of microcapsules 1j on a first substrate 1a by use of nozzles according to the ink jet method.

When the resultant electrophoretic display device is subjected to contrast display for a long time by driving it at a drive voltage of ±10V, the electrophoretic particles 1e are excellent in dispersibility, and chargeability, and it is possible to effect clear white/black display.

### EXAMPLE 19

In dichloromethane, living cationic polymerization is performed for a predetermined time at −40° C. by using octyl vinyl ether, a functional polymerization initiator having a phthalimide group represented by a formula (7) shown below, and zinc dichloride.

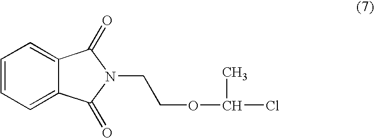

As a result, poly(octyl vinyl ether) having a terminal phthalimide group is obtained.

The thus obtained poly(octadecyl vinyl ether) is subjected to hydrolysis treatment to protect the terminal phthalimide group with amino group from elimination, thus preparing poly(octyl vinyl ether) which has a terminal amino group, a number-average molecular weight of about 15,000 and a molecular weight distribution index of 1.14.

Separately, in a similar manner, poly(2-chloroethyl vinyl ether) which has a terminal amino group, a number-average molecular weight of about 20,000, and a molecular weight distribution index of 1.09 is obtained.

Then, the above prepared poly(octyl vinyl ether) having a terminal amino group and the poly(2-chloroethyl vinyl ether) are mixed in an equivalent amount. The resultant mixture is reacted in hexane with particles for carbon black (“Color Black FW 200”, mfd. by Degussa AG) having isocyanate group at each particle surface by treating the particles with tolylene diisocianate in the same manner as in Example 13.

After the reaction, the resultant particles are washed and dried to obtain objective particles for a particle movement type display apparatus. An average particle size of the particles is about 0.14 μm.

The thus obtained particles are well dispersed in chloroform, so that it is possible to confirm that poly(octyl vinyl ether) and poly(2-chloroethyl vinyl ether) each of which has a uniform polymer chain length are grafted at the pigment particle surface.

The above prepared particles for the particle movement type display apparatus are used as electrophoretic particles 4e in the following manner. An electrophoretic particle dispersion liquid is prepared by using 3 wt. % of the core particles as electrophoretic particles (black pigment particles), 1.5 wt. % of rosin acid, and 95.5 wt. % of an electrophoretic particle dispersion medium 4f (“Isoper H, mfd. by Exxon Corp.). The electrophoretic particles to which poly(octylvinyl ether) and poly(2-chloroethyl vinyl ether) are grafted are positively charged.

The electrophoretic particle dispersion liquid is injected into a cell by using nozzles according to an ink jet method to provide an electrophoretic display device, as shown in FIG. 4(a), which is connected with a voltage application circuit.

When the resultant electrophoretic display device is subjected to contrast display for a long time by driving it at a drive voltage of ±10V, the electrophoretic particles 4e are excellent in dispersibility and chargeability, and it is possible to effect clear white/black display.

### EXAMPLE 20

A plurality of microcapsules 4j each containing an electrophoretic particle dispersion liquid prepared in the same manner as in Example 19 are prepared by interfacial polymerization method. Each microcapsule is formed of polyamide resin as a film-forming material. An electrophoretic display device, as shown in FIG. 4(b), which is connected with a voltage application circuit is prepared by disposing the plurality of microcapsules 4j on a first substrate 4a by use of nozzles according to the ink jet method.

When the resultant electrophoretic display device is subjected to contrast display for a long time by driving it at a drive voltage of ±10V, the electrophoretic particles are excellent in dispersibility and chargeability, and it is possible to effect clear white/black display.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 308626/2004 filed Oct. 22, 2004, which is hereby incorporated by reference.

What is claimed is:

1. A process for producing particles for a particle movement type display apparatus, comprising:
a step of preparing at least one of pigment particles or composite particles comprising a colorant and a polymer, and
a step of forming and fixing a polymeric compound at a surface of pigment particle or composite particle by a precise ionic polymerization.

2. A process according to claim 1, wherein the forming and fixing step is performed by elongation grafting, through the precise ionic polymerization, of the polymeric compound from a precise ionic polymerization initiation group on the surface of pigment particle or composite particle.

3. A process according to claim 1, wherein the forming and fixing step is performed by implantation grafting which reacts a functional group (A) on the surface of pigment particle or composite particle with functional group (B) of a polymeric compound which is prepared in advance by the precise ionic polymerization.

4. Particles for particle movement type display apparatus, comprising: particles which comprise pigment particles or composite particles comprising a colorant and a polymer, and a polymeric compound which is prepared by a precise ionic polymerization and is fixed at a surface of pigment particle or composite particle by a covalent bond.

5. Particles according to claim 4, wherein the polymeric compound which is fixed at the surface of pigment particle or composite particle has a molecular weight distribution index (weight-average molecular weight/number-average molecular weight) of not more than 1.8.

6. An electrophoretic display apparatus, comprising:
particles for a particle movement type display apparatus according to claim 4,
a container for containing a dispersion liquid which contains a dispersion medium for dispersing said particles,
a display portion provided in at least a part of said container, and
voltage application means for applying a voltage for causing movement of said particles to said display portion depending on display information.
